(19) United States
(12) Patent Application Publication
(10) Pub. No.: US 2023/0291821 A1
(43) Pub. Date: Sep. 14, 2023

(54) FOLDABLE GRIP FOR MOBILE DEVICE

(71) Applicant: Google LLC, Mountain View, CA (US)

(72) Inventors: Yu BAI, Sunnyvale, CA (US); Nick Gillett, San Francisco, CA (US); Roger Nihl Re, San Jose, CA (US)

(21) Appl. No.: 18/174,271

(22) Filed: Feb. 24, 2023

Related U.S. Application Data
(60) Provisional application No. 63/313,669, filed on Feb. 24, 2022.

(51) Int. Cl. H04M 1/04

(52) U.S. Cl. CPC H04M 1/04

(57) ABSTRACT

A foldable grip is provided on the back panel of a mobile device to enable comfortable and secure holding of the device even during extended use. The grip structure has two main parts, a base that is integrally connected to the panel, and a grip element that is mounted to the base. The grip element moves from a resting position that is flat and flush with the panel of the mobile device to a deployed position in which at least a portion of the grip element folds and curves away from the base to provide a curved surface for a user’s hand to engage. The flat resting position of the trip element ensures that the slim form factor of the device is not disrupted and that a sleek appearance is

### CROSS-REFERENCE TO RELATED APPLICATION

This application claims priority to Provisional Application No. 63/313,669, filed Feb. 24, 2022, the entire contents of which are hereby incorporated by reference.

### BACKGROUND

### 1. Field of the Disclosure

The present disclosure relates to a foldable grip for a mobile device with a generally flat position that is generally flush with the surface of the device, and a deployed position that presents a surface to engage with a user’s hand or acts as a kickstand to support the device.

### 2. Description of Related Art

Mobile devices such as mobile phones can be heavy and awkward to hold for longer periods by the edges. Mobile devices do not have stands so an accessory stand or attachment must be used to position the device at a desired viewing angle.

Existing grips and stands include a button type of accessory that attaches to the back of a mobile device. The button is bulky, and the sleek design of the device is usually compromised to provide a grip for the user’s hand. Moreover, some buttons are extendable to provide an even larger extension from the back of the device to provide more room for the user’s hand or a larger user’s hand, or to act as a kickstand. Another type of grip is a circular ring that is attached to the back of a mobile device, with the ring mounted to open outward to enable a user to insert a finger into the ring. A limitation of the ring type of grip is that the size will only accommodate an average sized user’s hand so very small hands or very large hands cannot comfortably use the grip. Moreover, the ring and its attachment swivel protrude from the back of the mobile device and present as a bulky bump on the device. Yet another type of grip includes a metal ring that attaches to a magnetic back of a mobile device with a grip nestled in the ring to provide an extended gripping area or an angled kickstand. The grip is a panel that overlays a user’s finger and is biased toward the mobile device. If used for an extended period of time, the grip can become uncomfortable as it is putting pressure on the user’s hand. And again, this type of grip must be sized for an average range of hand sizes and might not be optimal for small or large hands outside of an average size range. All these existing grips are separate accessories that attach to the back of a mobile device either magnetically or adhesively.

There is a need for a mobile device grip that is integrated with the mobile device case and remains flat when not in use so as to maintain the thin and sleek design of the mobile device and provide a comfortable grip for a user’s hand when deployed. In addition, the grip should not interfere with wireless charging or require removal for wireless charging. Throughout this disclosure, a case refers to either the back panel of a mobile device housing or a separate auxiliary case for a mobile device.

### SUMMARY OF THE INVENTION

To provide a secure grip for a user’s hand on a mobile device while not detracting from the device’s sleek and thin design, a foldable grip is integrated with the back panel of the device. The grip has two main parts, a base that is integrally connected to the panel, and a grip element that is mounted to the base. The grip element moves from a resting position that is flat and flush with the panel of the mobile device to a deployed position in which at least a portion of the grip element folds and curves away from the base to provide a curved surface for a user’s hand to engage. The flat resting position of the grip element ensures that the slim form factor of the device is not disrupted and that a sleek appearance is maintained.

The deployed position of the grip element is one in which at least a portion of the grip element extends away from the panel to provide the curved engagement surface.

The grip element may be circular, and the foldable area may be a secant portion of the circle, or two opposing secant portions which fold away from the panel and toward each other to provide a curved enclosure.

The grip element may be configured to fold to greater and lesser degrees to provide different curvatures. The grip is rotatable with respect to the panel, and this might be achieved by rotatably connecting the base to the panel, or alternatively, rotatably mounting the grip element to a base that is in a fixed position with respect to the panel.

The foldable grip may be disposed in various locations on the panel. For example, it may be disposed in a central area of the panel or may be disposed on a portion of the panel that is offset from the central area, either above the central area or below the central area.

The foldable grip may be configured to receive one or more fingers of a user’s hand to securely hold the mobile device.

The foldable grip may also be provided as a separate element that can be attached to a mobile device housing via various methods such as adhesive, magnet, threaded or mated fasteners or other mechanisms.

The foldable grip element or moving part may change between a flat or close to flat shape, to a curved shape. The user can activate this movement by pressing at the center and/or pulling at its peripheral/edge, or other action.

When curved, the moving part stays stable. Users may place one or more fingers inside the curved part to hold the device.

When curved, it may be used as a kickstand.

The size of the moving part may be selected to fit a wide range of finger sizes.

Alternatively, several of the said moving parts of various sizes may be provided along with the base for the users to choose from.

It will be designed to not interfere with wireless charging.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a perspective view of a back panel of a mobile device case showing a resting position of the grip element.

FIG. 2 is a perspective view of the back panel of FIG. 1 showing a deployed position of the grip element.

FIG. 3 is an elevational view of the back panel of FIG. 1.

FIG. 4 is a side elevational view of one side of the back panel of FIG. 1.

FIG. 5 is a side elevational view of the opposite side of the back panel of FIG. 1.

FIG. 6 is a top plan view of the back panel of FIG. 1.

FIG. 7 is a bottom plan view of the back panel of FIG. 1.

FIG. 8 is an elevational view of another embodiment of the back panel of a mobile device case showing a deployed position of the grip element with the curved portions providing a horizontally oriented channel.

FIG. 9 is a side elevational view of one side of the back panel of FIG. 8.

FIG. 10 a side elevational view of the opposite side of the back panel of FIG. 8.

FIG. 11 is a top plan view of the back panel of FIG. 8.

FIG. 12 is a bottom plan view of the back panel of FIG. 8.

FIG. 13 is a perspective view of another embodiment of the back panel of a mobile device case showing a deployed position of the grip element with the curved portions providing a vertically oriented channel.

FIG. 14 is an elevational view of the back panel of FIG. 13.

FIG. 15 is a side elevational view of the back panel of FIG. 13, the opposite side elevational view being a mirror image thereof.

FIG. 16 is a top plan view of the back panel of FIG. 13, the bottom plan view being a mirror image thereof concerning the grip element.

FIG. 17 is a perspective view of another embodiment of the back panel of a mobile device case showing a deployed position of the grip element with the curved portions rotated approximately 45 degrees from the previous embodiment.

FIG. 18 is an elevational view of the back panel of FIG. 17.

FIG. 19 is a side elevational view of the back panel of FIG. 17, the opposite side elevational view being a mirror image thereof.

FIG. 20 is a top plan view of the back panel of FIG. 17, the bottom plan view being a mirror image thereof concerning the grip element.

FIG. 21 is a perspective view of another embodiment of the back panel of a mobile device case showing a deployed position of the grip element with a greater degree of curvature.

FIG. 22 is an elevational view of the back panel of FIG. 21.

FIG. 23 is a side elevational view of the back panel of FIG. 21, the opposite side elevational view being a mirror image thereof.

FIG. 24 is a top plan view of the back panel of FIG. 21, the bottom plan view being a mirror image thereof concerning the grip element.

FIG. 25 is a perspective view of another embodiment of the back panel of a mobile device case showing a deployed position of the grip element disposed in a location offset from a central area.

FIG. 26 is an elevational view of the back panel of FIG. 25.

FIG. 27 is a side elevational view of the back panel of FIG. 25, the opposite side elevational view being a mirror image thereof.

FIG. 28 is a top plan view of the back panel of FIG. 25, the bottom plan view being a mirror image thereof concerning the grip element.

FIG. 29 is a closeup perspective view of the foldable grip structure shown in isolation.

FIG. 30 is an opposite closeup perspective view of the foldable grip structure of FIG. 29.

FIG. 31 is another closeup perspective view of the foldable grip structure of FIG. 29.

FIG. 32 is another closeup perspective view of the foldable grip structure of FIG. 29.

FIG. 33 is an elevational view of the foldable grip structure of FIG. 29.

FIG. 34 is a side elevational view of one side of the foldable grip structure of FIG. 29.

FIG. 35 is a side elevational view of the opposite side of the foldable grip structure of FIG. 29.

FIG. 36 is a top plan view of the foldable grip structure of FIG. 29.

FIG. 37 is a bottom plan view of the foldable grip structure of FIG. 29.

### DETAILED DESCRIPTION

To facilitate comfortable and secure use of a mobile device, a foldable grip is provided on a back panel of a mobile device case. As stated previously, the term case in this disclosure may refer to the housing of a mobile device or an auxiliary or protective case for the mobile device. The case will include a back panel which is where a user’s hand normally rests during use. With the sleek and thin designs of mobile devices, securing and comfortably holding the device, especially for longer periods of time or in inclement conditions may present a risk of the device slipping from the user’s hand or being dropped. Various grips have been used, many of which present bulky attachments detracting from the design of the device and making easy stowage of the device into a pocket, slipcase, or bag cumbersome or impossible. In addition, previous attachable grips interfere with wireless charging and must be removed and stored while the device is charging.

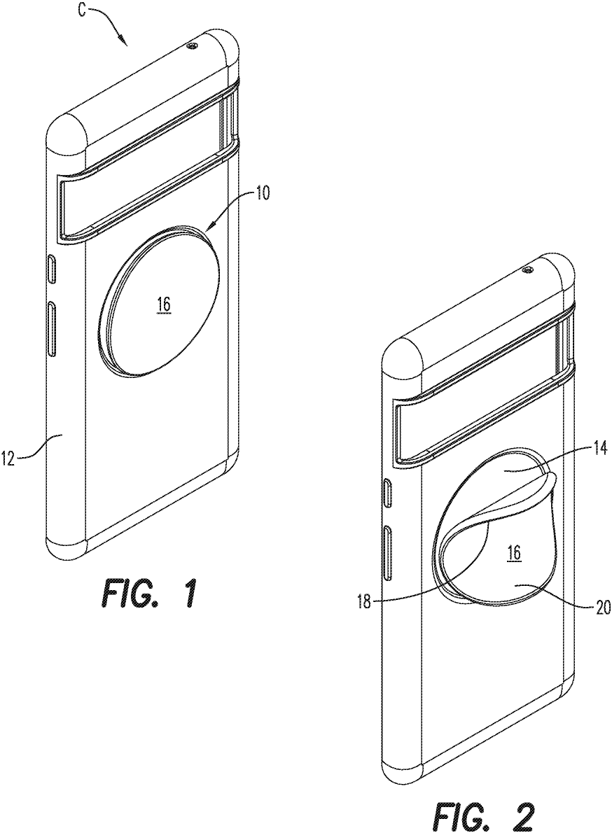

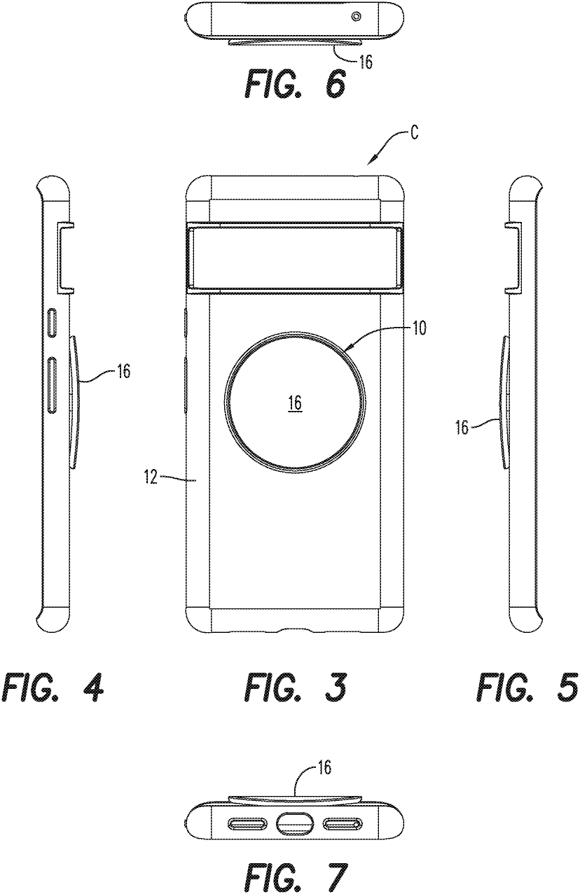

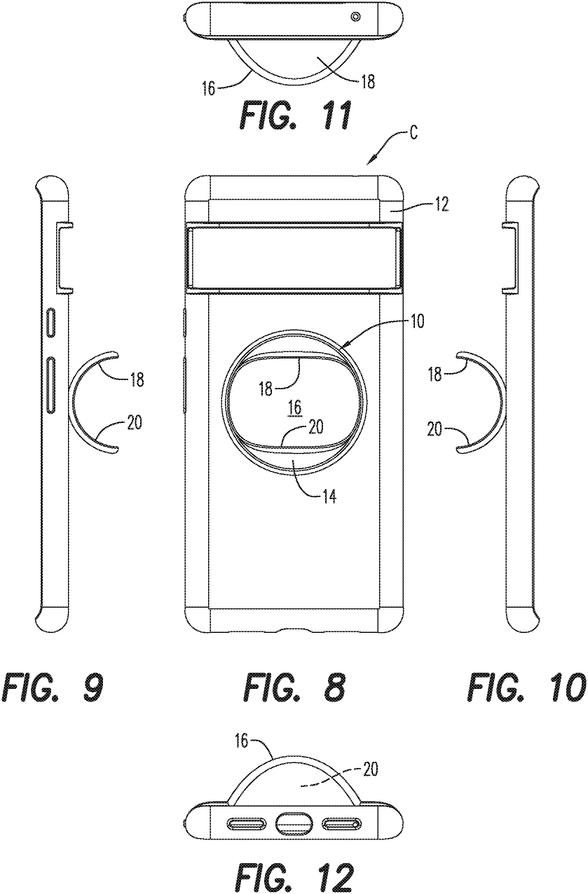

Referring now to the figures, the present disclosure describes various embodiments of a foldable grip structure 10 that may be integrated into a back panel 12 of a mobile device case C. Like reference numerals will be used for like structures throughout all the illustrated embodiments. The case and back panel 12 in the illustrated embodiment are not limiting in any way and have various control buttons, cut-outs, and the like as commonly present on mobile device cases. Grip structure 10 comprises a base portion 14 and a foldable grip element 16. In the embodiment of FIGS. 1-12, grip structure 10 is shown as being generally centrally located on back panel 12. As seen in FIGS. 1 and 3-7, grip element 16 is shown in a resting position in which it is flat and flush with the back panel. In the illustrated embodiments the grip element is generally shown as a circular element, however there is no geometric limitation to the shape and size of the grip element. It might be rectangular, lozenge shaped, racetrack shaped, or a myriad of other shapes which might be foldable from a flat position to a deployed position in which at least one section can be folded, bent or curved to extend away from the back panel and outward to provide curved surface to engage a user’s hand.

In a deployed position as shown in FIGS. 2 and 8-12, grip element 16 is shown with secant sections on the bottom and top of the circular element curved away from the panel and extending outward to provide a curved top surface 18 and a curved bottom surface 20 which may engage a user’s hand or finger when holding the device. The interior curved surfaces are labeled 18 and 20, and together they form a taco-like shape when deployed to engage a user’s hand or fingers. These curved surfaces provide comfortable supporting surfaces enabling a user to comfortably and securing grip the mobile device.

Grip element 16 is contemplated to be made of various materials with material properties that will enable it to have at least a resting, flat position and a deployed, curve or extending position. This might be achieved with moldable materials or with a spring steel mechanism designed to bias into either a resting position or a deployed position. A spring steel mechanism may be covered with a tactile material such as rubber, plastic, or silicone to provide a comfortable engagement with a user’s hand. The deployed position may be achieved by moving the desired portions of the grip element into an extended position. Alternatively, the deployed position may be achieved in a spring steel mechanism by depressing a center area that releases the mechanism from the flat, resting position into the curved and extending deployed position. While the illustrated embodiments show one deployed position, it is within the purview of the disclosure to provide for a range of deployed positions varying from almost flat to a curvature that is greater than the illustrated embodiments, all for the sake of being able to comfortably and securing hold the device in a variety of situations. In addition, the deployed position may enable the grip element to be used as a kickstand to rest the device at a desired viewing angle on a tabletop or the like. Also, while the illustrated embodiment show a grip element that has opposing sections curved and extending, it is also contemplated that only one side of the grip element might deploy to provide a single extending section or curved surface to engage a user’s hand.

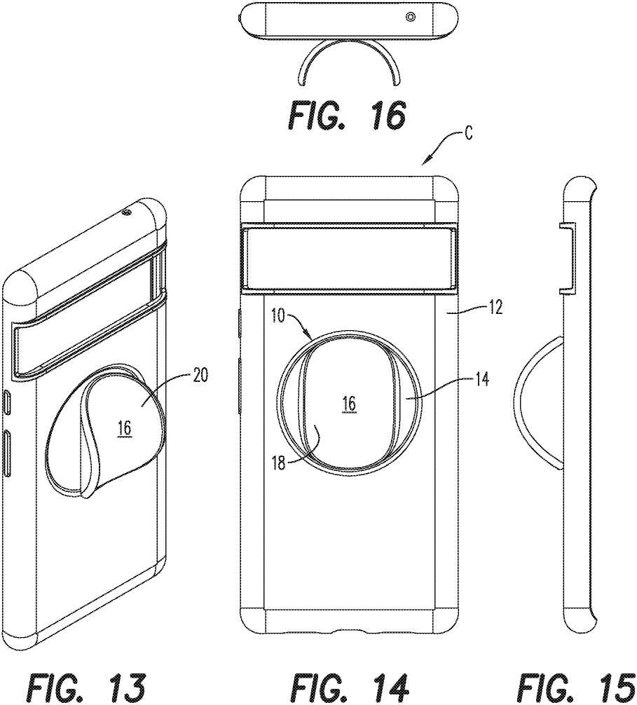

Turning to the embodiment illustrated in FIGS. 13-16, foldable grip structure 10 includes a base 14 and a grip element 16 as in the earlier embodiment. The difference in FIGS. 13-16 is that the grip element’s orientation is rotated about 90 degrees from the embodiment of FIGS. 1-12. In this embodiment curved surfaces 18 and 20 comprises the left and right internal surfaces of the curved secant sections of grip element 16. The rotatable positioning of the trip structure enables a user to hold the device in either a portrait or landscape orientation, or any angle in between. The rotational movement of the grip structure may be accomplished in various ways. For example, the base might be fixed in relation to the panel and the grip element is mounted to the base to enable it to rotate with respect to the base. This movement of the grip element relative to the base may be achieved with a variety of mechanisms such as frictional pin and aperture, a sprocket arrangement, teeth and mating detents or the like. Alternatively, the base and grip element may be in a fixed relation to one another and move as an integrated body with respect to the aperture in the panel in which the base is connected. This type of rotational movement of the grip structure relative to the panel may be accomplished in a variety of ways such as a tongue and groove mating relationship between the base and panel, or any other suitable mechanism such as those described above.

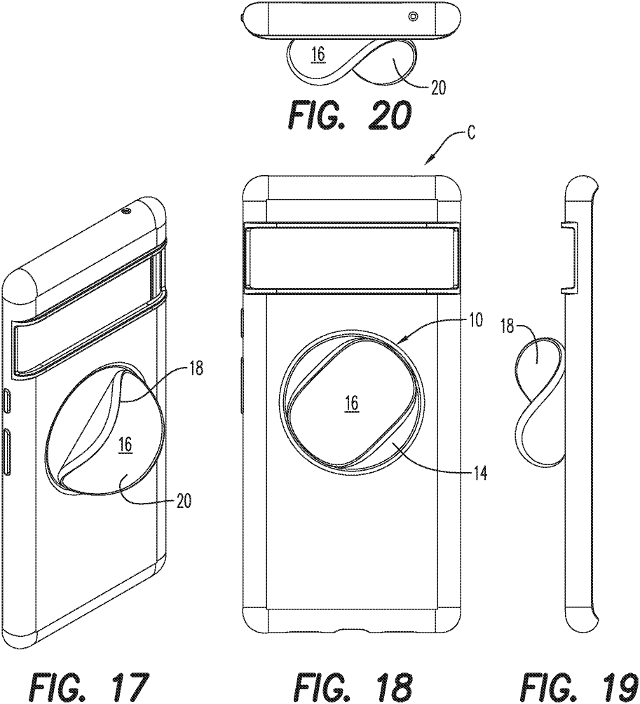

Turning to the embodiment illustrated in FIGS. 17-20, foldable grip structure 10 includes a base 14 and a grip element 16 as in the earlier embodiment. The difference between the embodiment of FIGS. 17-20 and the embodiment of FIGS. 13-16 is that the grip element’s orientation is rotated about 45 degrees from shown in FIGS. 13-16 and FIGS. 1-12. In this embodiment curved surfaces 18 and 20 comprise the upper northwest and lower southeast curved secant sections of grip element 16, as viewed with reference to FIG. 18. Again, the grip structure may be rotatable in similar fashion as described above.

While the illustrated positions of FIGS. 1-12, FIGS. 13-16, and FIGS. 17-20 are described as embodiments, it will be understood that a single device according to the present disclosure may exhibit all of these states depending on the rotational position of the grip structure on the panel. Therefore, these figures maybe thought of as illustrating different states of the same mechanism.

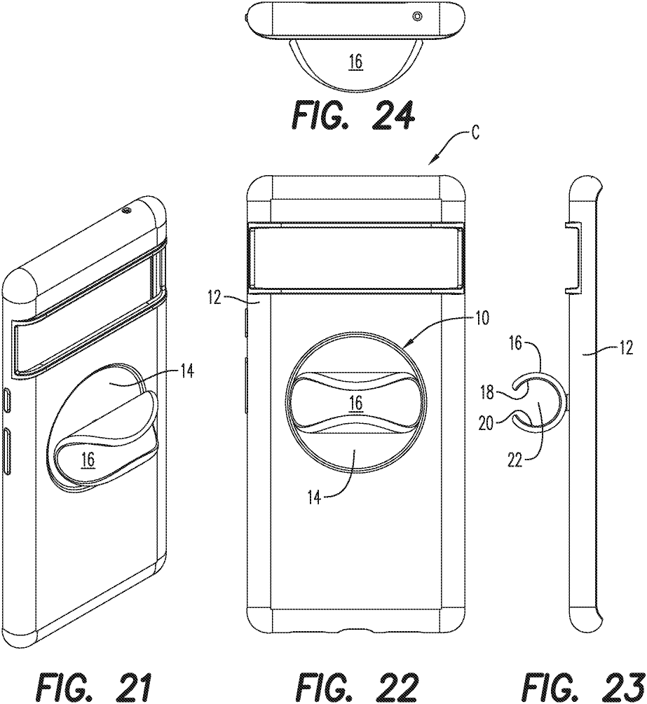

Turning to the embodiment illustrated in FIGS. 21-24, foldable grip structure 10 includes a base 14 and a grip element 16 as in the earlier embodiments. The difference is that this embodiment shows more curvature of the secant portions such that the curved surfaces 18 and 20 define a narrower channel 22 between the surfaces to make it possible to enclose a user’s finger more tightly. Again, the grip structure may be rotatable in similar fashion as described above to a desired angle with respect to the horizontal.

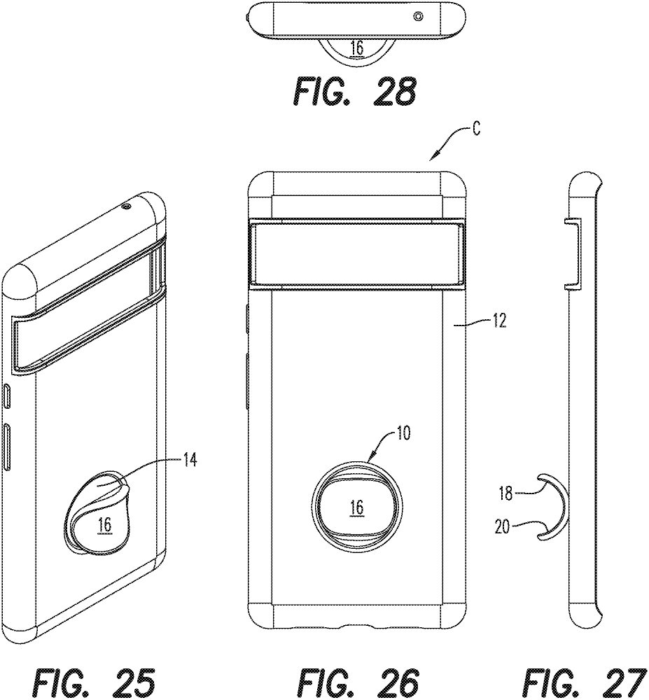

Turning to the embodiment illustrated in FIGS. 25-28, foldable grip structure 10 includes a base 14 and a grip element 16 as in the earlier embodiments. The difference is that this embodiment shows the grip structure located on the back panel in a position offset from a central area, that is, in the lower portion of the back panel. Depending on the size of the device, the user’s hand size and usage behavior, it might be advantageous to employ a grip structure that is smaller than the previous embodiments and located on the back panel in other locations than the central area. All the variations of grip structure size and location are within the purview of the disclosure. Again, the grip structure may be rotatable in similar fashion as described above to a desired angle with respect to the horizontal.

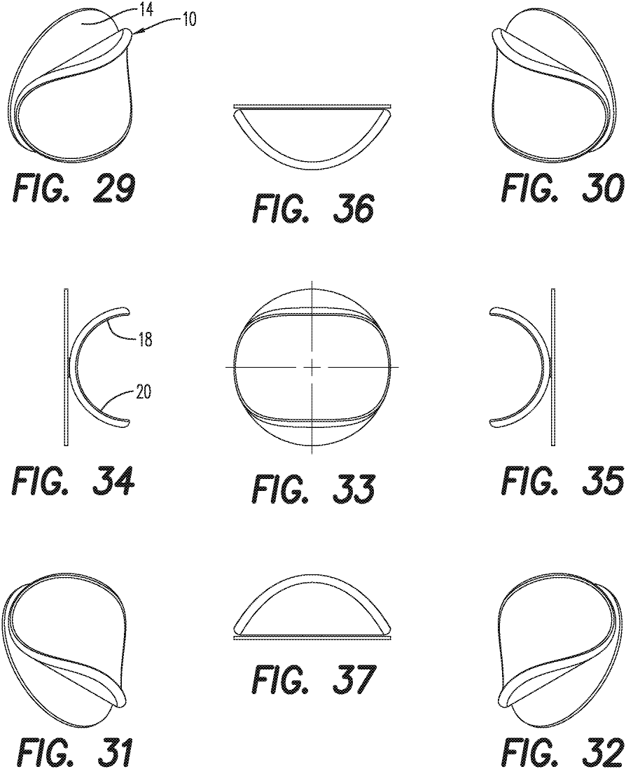

FIGS. 29-37 illustrate various close-up views of the grip structure 10 in a deployed position to provide more detail of the curvatures that may be possible with the contemplated design.

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. Also, various modifications and changes may be made within the scope of the attached claims.

We claim:

1. A foldable grip integrated into a panel of a mobile device case, said grip comprising:
a base integrally connected to the panel;
a grip element mounted to said base wherein said grip element has a flat resting position and an extending deployed position.

2. The foldable grip of claim 1, wherein the extending deployed position comprises a portion of said grip element being folded and curved away from the panel to provide a curved surface adapted to engage a user’s hand.

3. The foldable grip of claim 1, wherein said grip element is circular.

4. The foldable grip of claim 3, wherein the extending deployed position comprises opposing secant portions of said grip element being folded and curved away from the panel and toward each other to provide a curved enclosure adapted to engage a user’s hand.

5. The foldable grip of claim 4, wherein said grip element is configured to fold to greater and lesser degrees to provide different curvatures of the portion adapted to engage a user’s hand.

6. The foldable grip of claim 4, wherein said base is rotatably connected to the panel to enable rotational movement of said grip.

7. The foldable grip of claim 4, wherein said grip element is rotatably mounted to said base to enable rotational movement of said grip element.

8. The foldable grip of claim 4, wherein said grip is disposed in a central area of the panel.

9. The foldable grip of claim 4, wherein said grip is disposed in an area of the panel that is offset from a central area.

10. The foldable grip of claim 2, wherein said grip element is configured to fold to greater and lesser degrees to provide different curvatures of the portion adapted to engage a user’s hand.

11. The foldable grip of claim 2, wherein said base is rotatably connected to the panel to enable rotational movement of said grip.

12. The foldable grip of claim 2, wherein said grip element is rotatably mounted to said base to enable rotational movement of said grip element.

13. The foldable grip of claim 2, wherein said grip is disposed in a central area of the panel.

14. The foldable grip of claim 2, wherein said grip is disposed in an area of the panel that is offset from a central area.

15. The foldable grip of claim 2, wherein said grip element is configured to fold to greater and lesser degrees to provide different curvatures of the portion adapted to engage a user’s hand.

16. A mobile device case comprising:
a housing including a rear panel;
a foldable grip integrated into the rear panel, said grip comprising:
a base integrally connected to the panel, and
a grip element mounted to said base wherein said grip element has a flat resting position and an extending deployed position.

17. The mobile device case of claim 16, wherein the extending deployed position comprises a portion of said grip element being folded and curved away from the panel to provide a curved surface adapted to engage a user’s hand.

18. The foldable grip of claim 17, wherein said grip element is circular.

19. The foldable grip of claim 18, wherein the extending deployed position comprises opposing secant portions of said grip element being folded and curved away from the panel and toward each other to provide a curved enclosure adapted to engage a user’s hand.

20. The foldable grip of claim 19, wherein said grip element is configured to fold to greater and lesser degrees to provide different curvatures of the portion adapted to engage a user’s hand.
